(19) United States
(12) Patent Application Publication
(10) Pub. No.: US 2009/0067383 A1
(43) Pub. Date: Mar. 12, 2009

(54) METHOD AND APPARATUS FOR A FREQUENCY DIVISION DUPLEX COMMUNICATION USING A TIME DIVISION DUPLEX MODEM

(75) Inventors: Philip J. Fleming, Glen Ellyn, IL (US); Yuda Y. Luz, Buffalo Grove, IL (US); William A. Payne, Glen Ellyn, IL (US); Fan Wang, Chicago, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/853,998

(22) Filed: Sep. 12, 2007

(51) Int. Cl. H04Q 7/00

(52) U.S. Cl. 370/330

(57) ABSTRACT

The present invention is directed to an communication unit an antenna and at least two modem cards. The first modem card is coupled to the antenna so that the first modem card transmits a first transmit signal at a first frequency during a first period and receives a first received signal at a second frequency during a second time period. The second modem card couple to the antenna so that the second modem card transmits a second transmit signal at the first frequency during the second time period and receives a second receive signal at the second frequency during the first time period. The communication unit can also include a synchronizer that is coupled to the first and second modem cards to generate a signal to synchronize the transmit and receive signals transmitted and received by the antenna.

### FIELD OF THE INVENTION

The present invention relates generally to time division duplex and frequency division duplex communications and, in particular, using a time division duplex modems to produce frequency division duplex systems.

### BACKGROUND

Access points in worldwide interoperability microwave access (WiMAX) telecommunication technologies often support time division duplex (TDD) to transmit and receive signals with mobile stations on the same frequency. Base stations in other types of wireless communication technologies also use TDD signaling to transmit and receive signals with mobile stations. In TDD systems transmission is synchronized between all access points or base stations such that all downlink transmission occur in a first time period of a frame and all uplink transmissions occur in a second time period of the frame. As TDD systems operate at a given frequency, a TDD modem can only transmit or receive one signal at any one time and allow one frequency to be used for both downlink and uplink communications.

Frequency division duplex (FDD) systems can also be used to transmit and receive signals between an access point and user equipment or base stations and mobile stations. FDD systems separate downlink transmission from uplink reception by performing the two tasks on different carrier frequencies and at different times.

TDD and FDD systems are deployed depending on the availability of spectrums. In order to use existing TDD equipment in FDD systems, the uplink and downlink transmissions are separated both in time and frequency. The uplink and downlink transmissions use separate frequency bans, but uplink and downlink transmission also use separate time intervals. By transferring the uplink transmission to a frequency band that is separate from the downlink transmission band each band is used 50% of the time.

To overcome these disadvantages, TDD and FDD combined systems are developed that includes a first base station transmitting in a first downlink frame on a first carrier frequency and receiving in first uplink frames that have no time overlap with the first downlink frames where the reception is on a second carrier frequency in a second frequency band that has no frequency overlap with the first frequency band. A second base station transmits in a second downlink frame on the first carrier frequency and receives in a second uplink frame that has no time overlap with the second downlink frames on the second carrier frequency. As stated, this combined system requires multiple base stations that can have partially overlapping radio coverage areas but are geographically separate from one another in order to avoid transmissions from one base station disturbing reception from the other base station.

Alternatively, TDD and FDD combined systems include a single base station that utilizes two antennas. A switch is coupled between the two antennas so that one antenna is used to transmit in a first downlink frame on a first carrier frequency and receive in a first uplink frame that has no time overlap with the first downlink frame where the reception is on a second carrier frequency in a second frequency band that has no frequency overlap with the first frequency band. The second antenna transmits in a second downlink frame on the first carrier frequency and receives in a second uplink frame that has no time overlap with the second downlink frame on the second carrier frequency.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates is an example components of a wireless communication system used in accordance with some embodiments of the invention.

FIG. 2 illustrates an example of a sector diagram used in accordance with some embodiments of the invention.

FIG. 3 illustrates an example of another sector diagram used in accordance with some embodiments of the invention.

FIG. 4 illustrates an example of yet another sector diagram used in accordance with some embodiments of the invention.

FIG. 5 illustrates the frames transmitted and received at various frequencies in accordance with some embodiments of the invention.

FIG. 6 illustrates frames transmitted and received from various modems in accordance with some embodiments of the invention.

FIG. 7 illustrates a flow chart of the operation of the modems in accordance with some embodiments of the invention.

FIG. 8 illustrates another flow chart of the operation of the modems in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to provide a frequency division multiplex signal using a time division multiplex modem. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of providing a frequency division duplex signal from a time division duplex modem described herein. The non-processor circuits may include, but are not limited to, a radio receiver, a radio transmitter, signal drivers, clock circuits, power source circuits, and user input devices. As such, these functions may be interpreted as steps of a method to perform frequency division duplex signaling from time division duplex modems. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The present invention relates to a method that, from an antenna, transmits a first transmit signal at a first frequency during a first period and transmits a second transmit signal at the first frequency during a second period. From the same antenna, the method also receives a first received signal at a second frequency during the first period and receives a second received signal at the second frequency during the second period. The antenna is coupled to a first modem card that transmits the first transmit signal at the first frequency during the first period and receives the second received signal at the second frequency during the second period. Moreover, the antenna is coupled to a second modem card that transmits a second transmit signal at the first frequency during the second period and receives the first received signal at the second frequency during the first period. The present invention can be used in TDD systems that have one antenna that serves three sectors with one or more carriers or that serves four sectors with one or more carriers. The signals are transmitted and received so that they are non-interrupting and reduce interference between the sectors. Accordingly, the transmit and receive signals are time division duplex signals transmitted and received to emulate a frequency division duplex format.

In addition, the present invention is directed to an access point, base station or mobile station that includes an antenna and at least two modem cards. The first modem card is coupled to the antenna so that the first modem card transmits a first transmit signal at a first frequency during a first period and receives a first received signal at a second frequency during a second time period. The second modem card couple to the antenna so that the second modem card transmits a second transmit signal at the first frequency during the second time period and receives a second receive signal at the second frequency during the first time period. The access point or mobile station can also include a synchronizer that is coupled to the first and second modem cards to generate a signal to synchronize the transmit and receive signals transmitted and received by the antenna. The antenna can transmit and receive at the first and second frequencies in a plurality of sectors. Accordingly, the first and second modems and the antenna transmit and receive time division duplex signals to emulate a frequency division duplex format.

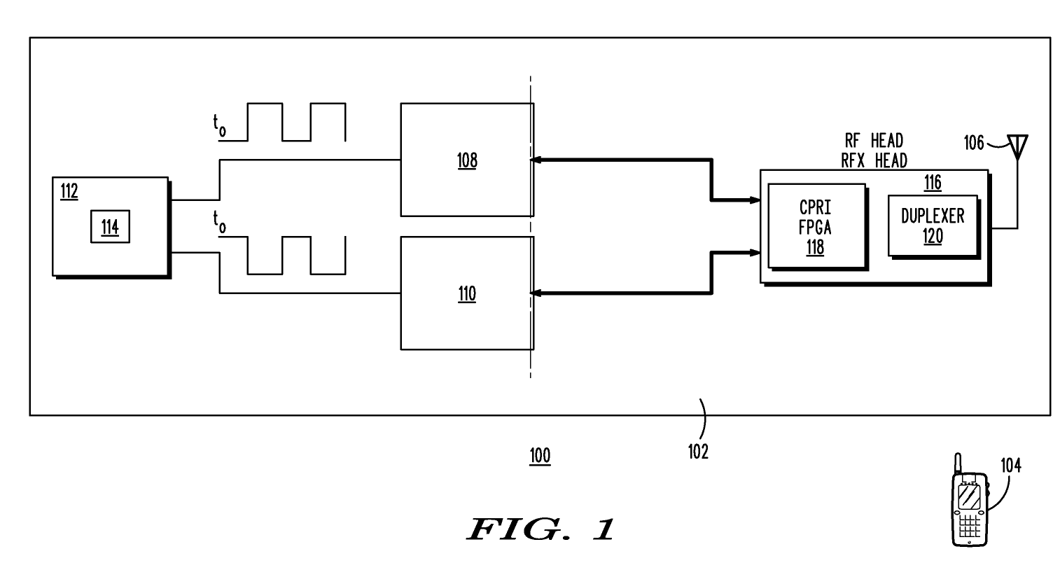

FIG. 1 illustrates a part of a wireless communication system 100 that can use WiMAX technology. The system includes at least one access point or base station 102 that transmits and receives signal to and from user equipment of mobile stations 104. In an embodiment, the access point 102 includes an antenna 106 that transmits and receives the signals. The signals are generated by a first modem card 108 and a second modem card 110. Modem cards 108, 110 are flex modems that are configured to operate in a WiMAX platform that uses time division duplex technology. The modem cards are coupled to a site controller board 112 that includes synchronizer 114. The site controller board 112 and synchronizer 114 are configured to frame sync signals 115 for the modem cards 108, 110 as described below. In addition, the access point 102 includes a radio frequency (RF) head card 116 coupled between the modem cards 108, 110 and the antenna 106. The RF head 116 is configured to operate using frequency division duplex technology. In an embodiment, the RF head card 116 includes a field programmable gate array card 118 and a duplexer 120 to operate the card in accordance with FDD technology. While FIG. 1 shows the access point 102 with two modem cards 108, 110, it is understood that a single modem card 108 can be programmed and operated by the site controller board 112 to operate the single modem card according to the principles described. In addition, the user equipment or mobile station 104 is configured in a similar fashion to operate in concert with the access point. For simplicity the user equipment 104 is not described in detail.

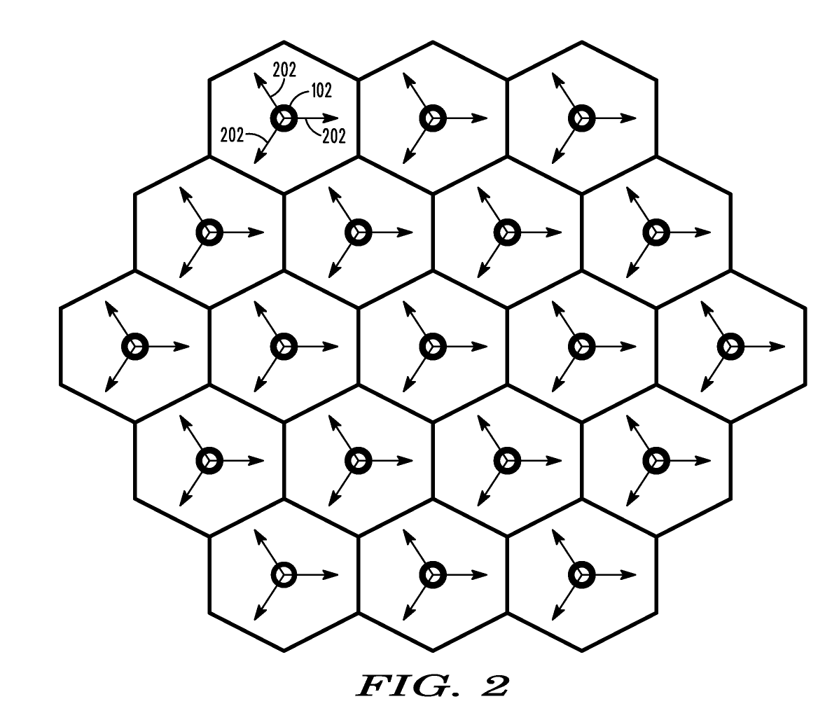

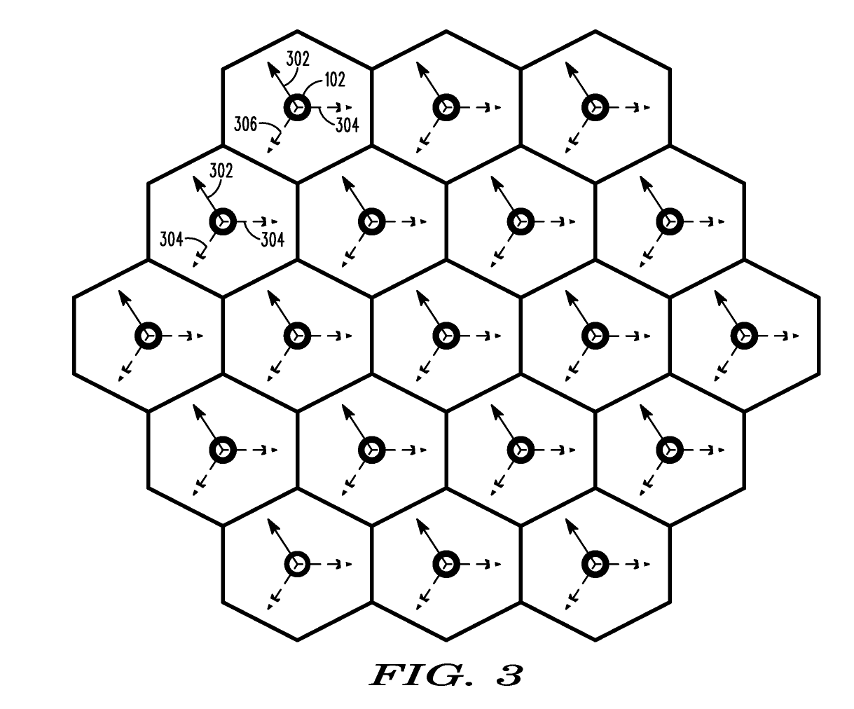

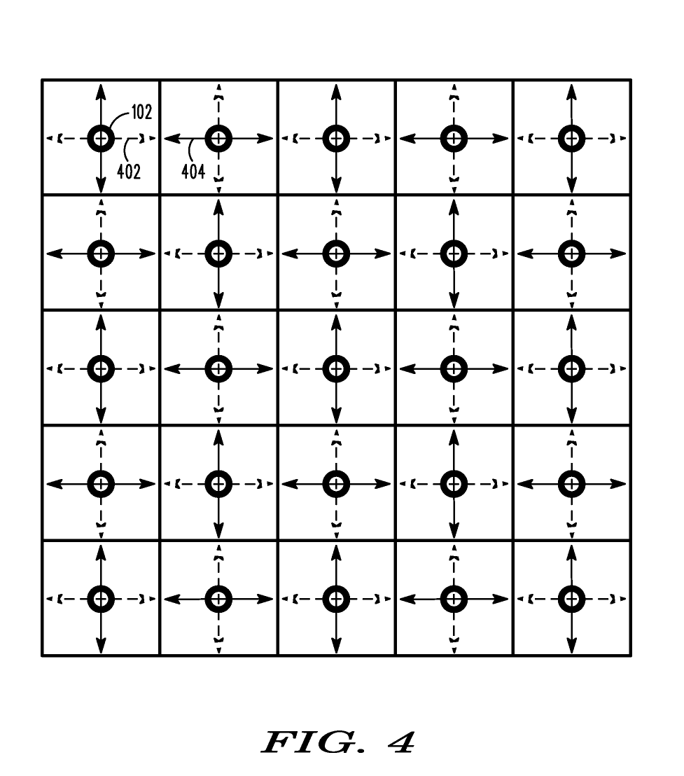

The access point 102 can operate in a different WiMAX configurations as shown in FIGS. 2-4. FIG. 2 shows a WiMAX configuration that includes multiple access points 102. Each access point includes one antenna that serves three sectors, illustrated by the arrows 202 pointing out from the access point. The access point operates using one RF channel. FIG. 3 shows a WiMAX configuration that includes multiple access points 102 where each access point has one antenna that serves three sectors, represented by arrow 302, 304, 306, and three RF channels, where each arrow 302, 304, 306 represents an RF pair. In this embodiment, each of the sectors operate using a all the different RF channels. As seen by the directions of the arrows, the RF channels are non-interrupting. FIG. 4 shows a WiMAX configuration that also includes multiple access points 102 where each access point has one antennas, but where the antenna serves four sectors. In this embodiment, the access point can be configured for one or more RF channels. Like the embodiments shown in FIGS. 2 and 3, the RF channels for the four sector configuration are non-interfering as described in more detail below.

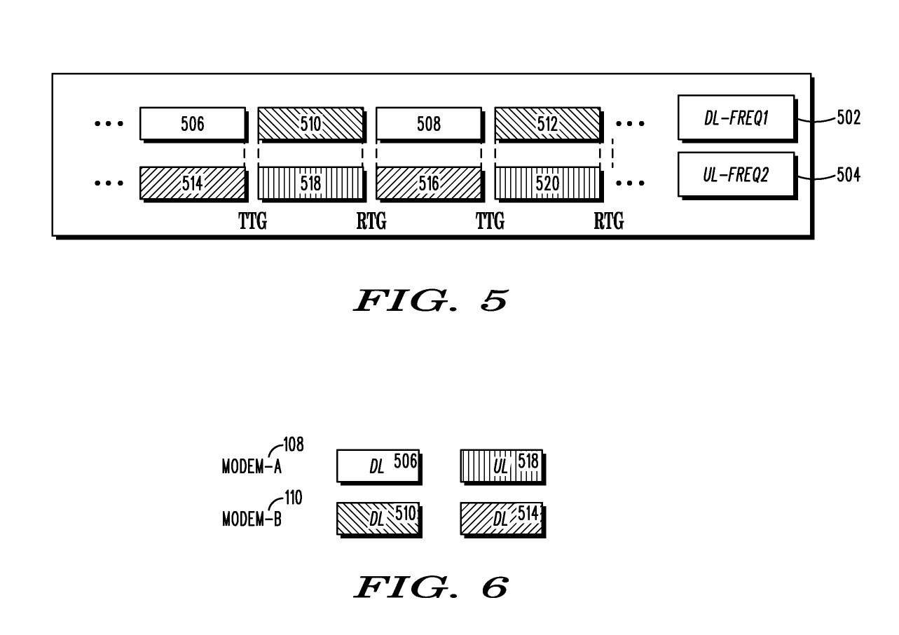

Referring to FIG. 5, usage of the downlink frequency and the uplink frequency is shown in accordance with the principles described such that an access point 102 can provide FDD signals using TDD technology. As explained, the downlink frequency 502 and uplink frequency 504 are generated by the RF head card 116 coupled to the two modem cards 108, 110, respectively, and sent from the same antenna 106. Downlink frames 506, 508 and uplink frames 518, 520 are generated using first modem card 106 and uplink frames 514, 516 and downlink frames 510, 512 are generated using second modem card 108. Modem cards 108, 110 drive the RF head card 116 such that the downlink frequency 502 includes downlink frames 506, 508 and 510, 512 generated by first modem card 106 and second modem card 108, respectively. Likewise, modem cards 108, 110 drive the RF head card 116 such that the uplink frequency includes uplink frames 510, 512 and 514, 516 generated by first modem card 106 and second modem card 108, respectively. As understood, each frame can be of a given time period and typically for TDD and FDD technologies the time period, or time length of a frame, is 5 msec. As seen, the downlink frames and uplink frames are separated by transmit time gap 522 and receive time gap 524. The time gaps 522, 524 can be approximately 2% of the duration of any frame. As seen, the arrangement of the downlink frames and the uplink frames in each of the downlink and uplink frequency approximate a full duplex connection between the access point 102 and the user equipment 104 instead of the standard half-duplex connection used when only one frequency is used.

FIG. 5 shows that by using at least two frequencies 502, 504 to communicate between the access node 102 and the user equipment 104 and time shifting the transmission and reception for the different frequencies, the blank time for any one frequency is filled in by the transmission and reception of the other frequency. The frames are therefore synchronized. In an embodiment, synchronizer 114 makes the necessary calculations to achieve the desired pattern of signals being generated from the RF head card 112. Thus, full rate channels are implemented using twosome slots in each downlink and uplink frame.

FIG. 6 illustrates the frames transmitted and received by modem cards 108, 110. First modem card 108 transmits signal 502 at the downlink frequency at the first time period. The first modem card 108 then receives signal 514 at the uplink frequency at the second time period. The second modem card 110 transmits signal 506 at the downlink frequency at the second time period. The second modem card 110 receives signal 510 at the uplink frequency at the first time period.

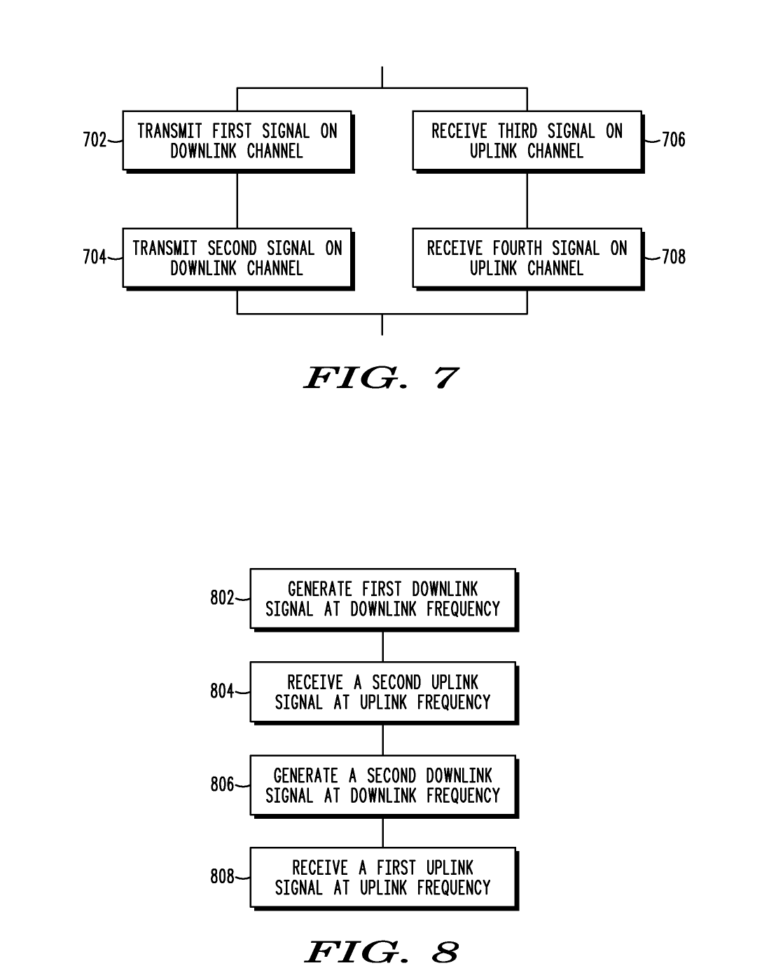

FIG. 7 is a flow chart illustrating the operation 600 of the access point 102 as it transmits and receives signals with user equipment 104. At a first frequency, the antenna 106 transmits 702 a first signal on a downlink channel between the access point and the user equipment during a first time period. At the same first frequency, the antenna 106 transmits 704 a second signal on the downlink channel during a second time period. During the first time period, as shown by the parallel paths, the antenna 106 receives 706 a third signal on an uplink channel between the access point and the user equipment. The third signal is received at a second frequency, which is different from the first frequency. At the same second frequency, the antenna receives 708 a fourth signal on an uplink channel during the second time period. As the access point is capable of transmitting signals at a plurality of frequencies, the first modem transmits first signal at the first frequency and receives the third signals at the second frequency according to TDD principles and the second modem transmits the second at the first frequency and receives the fourth signals at the second frequency also according to TDD principles. As the access point 102 is transmitting the first and second signals at the first downlink frequency while it is receive the third and forth signals at the second uplink frequency, the access point is effectively transmitting and receiving TDD signals according to a FDD principles.

FIG. 8 is a flow chart illustrating the operation 800 of the modems 108, 110 at access point 102 as it transmits and receives signals with user equipment 104. The first modem 108 generates 802 a first downlink signal 506 at the downlink frequency 502 during a first time period or frame. The first modem 108 also receives 804 a second uplink signal 512 at the second uplink frequency during a second time period or frame. The second modem 110 generates 806 a second downlink signal 508 at the downlink frequency during the second time period. In addition, the second modem 110 receives 808 a first uplink signal 510 at the second uplink frequency during a first time period. Accordingly, the first and second modems, which are configured to transmit and receive signals using TDD technology, synchronize the transmission and receipt of signals at the access point according to FDD technology such that the signals are transmitted from the access point to the user equipment on the first downlink frequency and are received at the access point from the user equipment on the second uplink frequency.

Returning to FIG. 4, an embodiment is illustrated such that each sector has one antenna at an access point or base station provides signals four sectors using at least one FDD frequency pair. The sectors are divided into two opposing pairs such that the vertical axis forms one sector pair and the horizontal axis forms a second sector pair. In the embodiment, each sector includes one modem card and one RF head, which generates signals at the downlink and uplink frequencies, alternating sectors can generate signal using one frequency such that odd sectors transmit on the downlink using a first downlink frequency during a frame while opposing sectors receive frames on the uplink frequency during the same frame. Thus at the intersection of each sector, opposing frequencies are used during each frame so that interference is reduced between the adjacent sectors.

In an embodiment having multiple sectors such as four sectors, each antenna can be driven by at least two frequency pairs that use TDD signals to emulate FDD signals. Referring to FIG. 4, the first frequency pair can be used to emulate FDD signals for one sector pair and the second frequency pair can be used to emulate FDD signals for the second sector pair. In this arrangement, each sector pair can alternate between frequency pairs. By using at least two frequency pairs, the radiation pattern of signals being transmitted and received in the first sector pair in one sector do not overlap with the radiation pattern of signals being transmitted and received in the first pair in an adjacent sector. Thus, interference between sectors is reduced in each direction of the sector pairs. As seen, the frequency pairs are used to transmit and receive signals in an interlaced format to resolve interference issues between sectors. In addition, the arrangement of interlaced frequency pairs provide for the efficiencies found by using emulated FDD signals in four sectors without interference.

In view of the foregoing, access points that are configured using TDD principles and equipment can effectively use FDD principles. Thus, the bandwidth throughput at each access point can be doubled for each frequency pair that is utilized. In addition, the half duplex configuration of TDD transmission can effectively emulate full duplex transmissions up to approximately 90% efficiency. This is achieved by programming a pair of TDD modem cards to operate at different frequencies, e.g. a frequency pair as described, for the downlink and uplink. The access point emulates full duplex by have two TDD modem cards synchronized to operate at alternating frequencies. Alternatively, the controller of one TDD modem can be configured to transmit and receive at different frequencies.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method comprising:
transmitting from an antenna a first transmit signal at a first frequency during a first period;
transmitting from the antenna a second transmit signal at the first frequency during a second period;
receiving at the antenna a first received signal at a second frequency during the first period, and
receiving at the antenna a second received signal at the second frequency during the second period, and
wherein the antenna is coupled to a first modem card for transmitting the first transmit signal at the first frequency during the first period and receiving the second received signal at the second frequency during the second period and the antenna is coupled to a second modem card for transmitting a second transmit signal at the first frequency during the second period and receiving a first received signal at the second frequency during the first period.

2. The method of claim 1 further comprising separating the first period from the second period by a time gap.

3. The method of claim 1 wherein the antenna transmits and receives at the first and second frequencies in a plurality of sectors.

4. The method of claim 3 wherein the signals transmitted and received from one of the plurality of sectors reduces interference with signals transmitted and received from an other of the plurality of sectors.

5. The method of claim 1 further comprising synchronizing the first transmit and received signals with the second transmit and received signals.

6. The method of claim 1 wherein the first and second time period form a frame.

7. The method of claim 1 wherein the transmit and receive signals are time division duplex signals transmitted and received in a frequency division duplex format.

8. The method of claim 1 wherein the first and second modem cards transmit and receive time division duplex signals emulating frequency division duplex signals.

9. The method of claim 1 wherein the first and second modem cars drive a radio frequency card coupled to the antenna.

10. The method of claim 1 wherein the first and second frequencies form a frequency pair and wherein the frequency pair wherein during a time period a signal is transmitted on one frequency of the frequency pair when an other signal is received the other frequency of the frequency pair.

11. An apparatus comprising:
an antenna;
a first modem card coupled to the antenna wherein the first modem card transmits a first transmit signal at a first frequency during a first period and receives a first received signal at a second frequency during a second time period, and
a second modem card couple to the antenna wherein the second modem card transmits a second transmit signal at the first frequency during the second time period and receives a second receive signal at the second frequency during the first time period.

12. The apparatus of claim 11 further comprising a synchronizer coupled to the first and second modem card to generate a signal to synchronize the transmit and receive signals transmitted and received by the antenna.

13. The apparatus of claim 12 wherein the synchronizer identifies the first and second transmit signals from the first and second received signals.

14. The apparatus of claim 11 wherein the first time period and the second time period form a frame.

15. The apparatus of claim 11 wherein the first and second modems transmit and receive time division duplex signals to emulate frequency division duplex signals.

16. The apparatus of claim 11 further comprising a radio frequency head coupled between the modem cards and the antenna.

17. The apparatus of claim 16 wherein the radio frequency head comprises a field programmable gate rate generator and a duplexer.

18. An apparatus comprising:
an antenna for transmitting and receiving signals in a sector wherein the sector is adjacent to an other sector;
a first modem card coupled to the antenna wherein the first modem card transmits a first transmit signal at a first frequency and receives a first received signal at a second frequency, and
a second modem card couple to the antenna wherein the second modem card transmits a second transmit signal at the first frequency and receives a second receive signal at the second frequency, and
wherein the first transmit signal is transmitted and the second receive signal is received in a first sector when the second transmit signal is transmitted and the first receive signal is received adjacent sector to reduce interference between the transmit signals and receive signals in the sectors.

19. The apparatus of claim 18 wherein the first and second frequencies form a first frequency pair and wherein the first and second modem cards transmit and receive signals on a second frequency pair such that signals are transmitted and received in one direction using alternating frequency pairs.

20. The apparatus of claim 19 wherein the transmit signals and the receive signals are time division duplex signals emulating frequency division duplex signals.
